(19) United States
(12) Patent Application Publication
(10) Pub. No.: US 2020/0043433 A1
(43) Pub. Date: Feb. 6, 2020

(54) SOURCE DRIVER WITH DATA DEPENDENT SHARED BUFFER DESIGN

(71) Applicant: Raydium Semiconductor Corporation, Hsinchu (TW)

(72) Inventors: MING-HENG TSAI, Hsinchu City (TW); CHIH-HSIEH JEN, Hsinchu City (TW); CHIH-CHUAN HUANG, Zhubei City (TW)

(21) Appl. No.: 16/520,529

(22) Filed: Jul. 24, 2019

(30) Foreign Application Priority Data
Jul. 31, 2018 (TW) 107126567

(51) Int. Cl. G09G 3/36

(52) U.S. Cl. CPC G09G 3/3685; G09G 3/3614; G09G 2310/027; G09G 2310/0289; G09G 2310/0291

(57) ABSTRACT

A source driver with data dependent shared buffer design including a first data judging unit, a first buffer, a second buffer and a first output switch unit is disclosed. The first data judging unit judges whether a first input data and a second input data having a first polarization are the same. The first buffer and second buffer, coupled to the first data judging unit, are used to temporarily store the first input data and second input data respectively. The output switch unit is coupled to the first data judging unit, an output terminal of first buffer and an output terminal of second buffer respectively. When a judging result of first data judging unit is YES, the first data judging unit turns off the first buffer or second buffer and conducts the first output switch unit, so that the output terminals of first buffer and second buffer are coupled.

### BACKGROUND OF THE INVENTION

### 1. Field of the Invention

The invention relates to a display; in particular, to a source driver with a data dependent shared buffer design.

### 2. Description of the Prior Art

In general, a source driver applied to a display device can include a plurality of outputs. For example, if a conventional source driver 1 having four outputs is taken as an example, as shown in FIG. 1, each of the output pads PAD1˜PAD4 respectively correspond to data latches DL1˜DL4 of different channels, and level shifters LS1˜LS4, digital-to-analog converters DAC1˜DAC4 and buffer units BF1˜BF4. And, the input data Dn˜Dn+3 are processed by the different channels respectively and then transmitted to the output pads PAD1˜PAD4 respectively, so that the four output pads PAD1˜PAD4 of the source driver 1 can output four output data Yn˜Yn+3 respectively.

However, since each of the output pads PAD1˜PAD4 of the conventional source driver 1 corresponds to one of the buffer units BF1˜BF4 respectively, no matter the input data Dn˜Dn+3 received by the conventional source driver 1 is the same or not, all buffer units BF1˜BF4 in the conventional source driver 1 should be simultaneously activated, so that the input data Dn˜Dn+3 temporarily stored in the buffer units BF1˜BF4 are transmitted to the output pads PAD1˜PAD4 respectively, it is hard of the conventional source driver 1 to effectively reduce its overall power consumption, so that it fails to achieve good energy saving effects and needs to be improved.

In view of this, the invention proposes a source driver having a data dependent shared buffer design to effectively solve the above problems encountered in the prior art.

### SUMMARY OF THE INVENTION

Therefore, the invention provides a source driver with a data dependent shared buffer design to solve the above-mentioned problems occurred in the prior arts.

An embodiment of the invention is a source driver with a data dependent shared buffer design. In this embodiment, the source driver includes a first data judging unit, a first data judging unit, a second buffer unit and a first output switch unit. The first data judging unit is configured to judge whether a first input data and a second input data having a first polarization are the same. The first buffer unit is coupled to the first data judging unit and configured to temporarily store the first input data. The second buffer unit is coupled to the first data judging unit and configured to temporarily store the second input data. The first output switch unit is coupled to the first data judging unit, an output terminal of the first buffer unit and an output terminal of the second buffer unit respectively. When a judging result of the first data judging unit is YES, the first data judging unit turns off the first buffer unit or the second buffer unit and conducts the first output switch unit, so that the output terminal of the first buffer unit and the output terminal of the second buffer unit are coupled.

In an embodiment, the source driver further includes a first output pad and a second output pad. The first output pad is coupled to the first buffer unit. The second output pad is coupled to the second buffer unit. When the first data judging unit turns off the first buffer unit, the second buffer unit outputs the second input data to the first output pad and the second output pad simultaneously; when the first data judging unit turns off the second buffer unit, the first buffer unit outputs the first input data to the first output pad and the second output pad simultaneously.

In an embodiment, when the judging result of the first data judging unit is NO, the first data judging unit disconnects the first output switch unit, so that the output terminal of the first buffer unit and the output terminal of the second buffer unit are disconnected, and the first buffer unit outputs the first input data to the first output pad and the second buffer unit outputs the second input data to the second output pad.

In an embodiment, the source driver further includes a first data latch and a second data latch. The first data latch is configured to receive and latch the first input data. The second data latch is configured to receive and latch the second input data. The first data judging unit is coupled to input terminals of the first data latch and the second data latch or the first data judging unit is coupled to output terminals of the first data latch and the second data latch.

In an embodiment, the source driver further includes a first level shifter, a second level shifter, a first digital-to-analog converter and a second digital-to-analog converter. The first level shifter is coupled to the output terminal of the first data latch and configured to shift a voltage level of the first input data. The second level shifter is coupled to the output terminal of the second data latch and configured to shift a voltage level of the second input data. The first digital-to-analog converter is coupled between the first level shifter and the first buffer unit and configured to convert the first input data from digital signal to analog signal and then transmit the converted first input data to the first buffer unit. The second digital-to-analog converter is coupled between the second level shifter and the second buffer unit and configured to convert the second input data from digital signal to analog signal and then transmit the converted second input data to the second buffer unit.

In an embodiment, the source driver further includes a second data judging unit, a third buffer unit, a fourth buffer unit and a second output switch unit. The second data judging unit is configured to judge whether a third input data and a fourth input data having a second polarization are the same, wherein the second polarization is different from the first polarization. The third buffer unit is coupled to the second data judging unit and configured to temporarily store the third input data. The fourth buffer unit is coupled to the second data judging unit and configured to temporarily store the fourth input data. The second output switch unit is coupled to the second data judging unit, an output terminal of the third buffer unit and an output terminal of the fourth buffer unit respectively. When a judging result of the second data judging unit is YES, the second data judging unit turns off the third buffer unit or the fourth buffer unit and conducts the second output switch unit, so that the output terminal of the third buffer unit and the output terminal of the fourth buffer unit are coupled.

In an embodiment, the source driver further includes a third output pad and a fourth output pad. The third output pad is coupled to the third buffer unit. The fourth output pad is coupled to the fourth buffer unit. when the second data judging unit turns off the third buffer unit, the fourth buffer unit outputs the fourth input data to the third output pad and the fourth output pad simultaneously; when the second data judging unit turns off the fourth buffer unit, the third buffer unit outputs the third input data to the third output pad and the fourth output pad simultaneously.

In an embodiment, when the judging result of the second data judging unit is NO, the second data judging unit disconnects the second output switch unit, so that the output terminal of the third buffer unit and the output terminal of the fourth buffer unit are disconnected, and the third buffer unit outputs the third input data to the third output pad and the fourth buffer unit outputs the fourth input data to the fourth output pad.

In an embodiment, the source driver further includes a third data latch and a fourth data latch. The third data latch is configured to receive and latch the third input data. The fourth data latch is configured to receive and latch the fourth input data. The second data judging unit is coupled to input terminals of the third data latch and the fourth data latch or the second data judging unit is coupled to output terminals of the third data latch and the fourth data latch.

In an embodiment, the source driver further includes a third level shifter, a fourth level shifter, a third digital-to-analog converter and a fourth digital-to-analog converter. The third level shifter is coupled to the output terminal of the third data latch and configured to shift a voltage level of the third input data. The fourth level shifter is coupled to the output terminal of the fourth data latch and configured to shift a voltage level of the fourth input data. The third digital-to-analog converter is coupled between the third level shifter and the third buffer unit and configured to convert the third input data from digital signal to analog signal and then transmit the converted third input data to the third buffer unit. The fourth digital-to-analog converter is coupled between the fourth level shifter and the fourth buffer unit and configured to convert the fourth input data from digital signal to analog signal and then transmit the converted fourth input data to the fourth buffer unit.

Another embodiment of the invention is also a source driver with a data dependent shared buffer design. In this embodiment, the source driver includes at least one data judging unit, (k+1) buffer units, an output switch array and (k+1) output pads. The at least one data judging unit is configured to judge whether (k+1) input data having the same polarization are the same, wherein k is a positive integer. The (k+1) buffer units is coupled to the at least one data judging unit and configured to temporarily store the (k+1) input data respectively. The output switch array is coupled to the at least one data judging unit and output terminals of the (k+1) buffer units respectively. The (k+1) output pads is coupled to the output switch array, corresponding to the (k+1) buffer units respectively. When the at least one data judging unit determines that m input data among the (k+1) input data are the same, the m input data are temporarily stored in m buffer units among the (k+1) buffer units, the at least one data judging unit turns off (m−1) buffer units among the m buffer units and the output switch array controls an output terminal of an only turned-on buffer unit among the m buffer units to be coupled to m output pads corresponding to the m buffer units among the (k+1) output pads simultaneously, so that the only turned-on buffer unit can output an input data temporarily stored in the only turned-on buffer unit to the m output pads simultaneously, m is a positive integer larger than 1.

Compared to the prior art, the source driver with the data dependent shared buffer design in the invention can adjust the number of the buffer units used by detecting whether the input data of each channel is the same, so as to avoid the unnecessary power consumption caused by activating all buffer units simultaneously. Therefore, the invention can effectively reduce the overall power consumption of the source driver and achieve the energy saving effect.

The advantage and spirit of the invention may be understood by the following detailed descriptions together with the appended drawings.

### BRIEF DESCRIPTION OF THE APPENDED DRAWINGS

FIG. 1 illustrates a schematic diagram showing that each of the output pads of the conventional source driver corresponds to one buffer unit respectively.

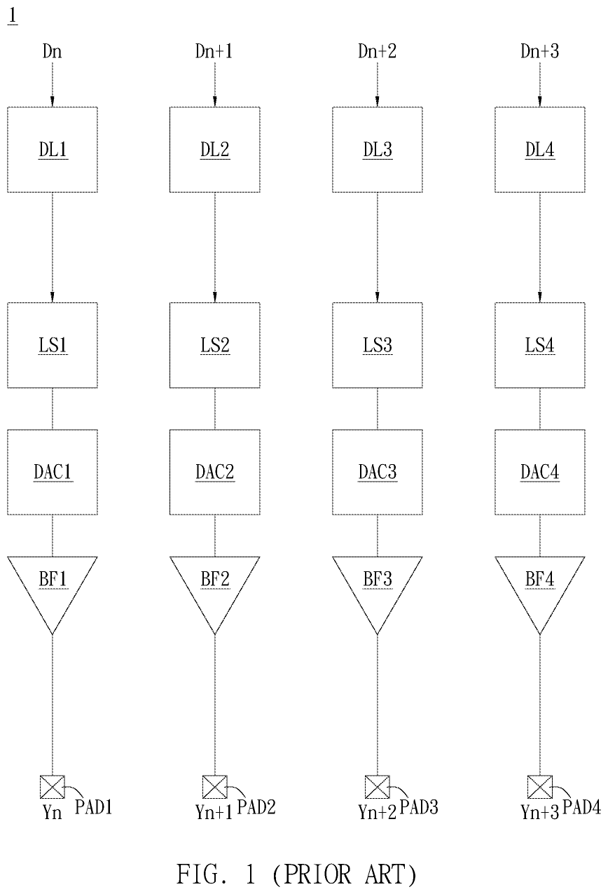

FIG. 2 illustrates a schematic diagram showing that a source driver with a data dependent shared buffer design simultaneously disconnects a first output switch unit and a second output switch unit and starts all buffer units according to the determination result of the first data judging unit and the second data judging in a preferred embodiment of the invention.

FIG. 3 illustrates a schematic diagram showing that the source driver with the data dependent shared buffer design in FIG. 2 simultaneously disconnects the first output switch unit and the second output switch unit and starts the first buffer unit and the third buffer unit according to the determination result of the first data judging unit and the second data judging unit.

FIG. 4 illustrates a schematic diagram showing that a source driver with a data dependent shared buffer design controls the switching of the output switch array according to the determination result of the data judging unit and activates only a part of the buffer units in another preferred embodiment of the invention.

### DETAILED DESCRIPTION OF THE INVENTION

An embodiment of the invention is a source driver having a data dependent shared buffer design. In this embodiment, the source driver can be applied to a liquid crystal display device and has a design of a data dependent shared buffer, but not limited to this.

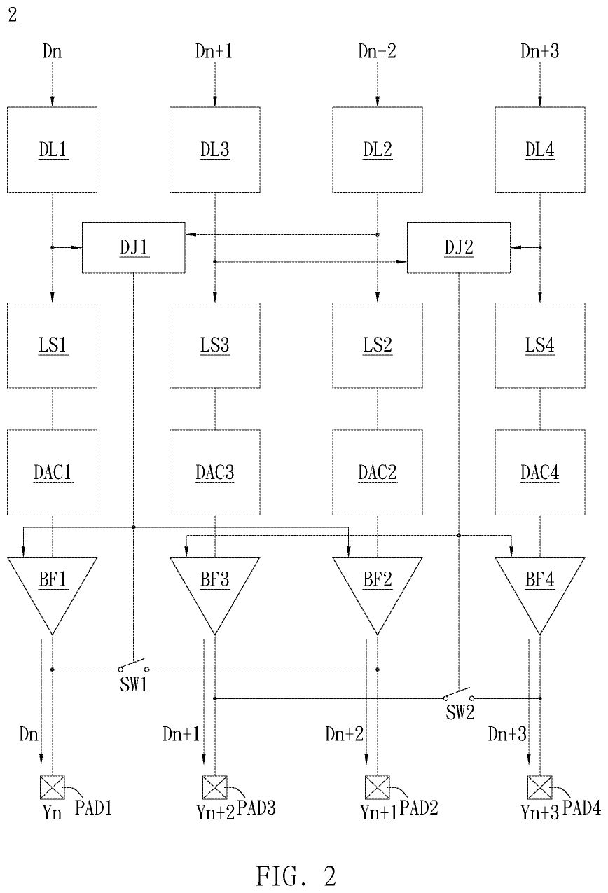

Please refer to FIG. 2. FIG. 2 illustrates a schematic diagram showing that the source driver 2 having a data dependent shared buffer design in this embodiment can simultaneously disconnect a first output switch unit SW1 and a second output switch unit SW2 and start all buffer units BF1˜BF4 according to the determination result of the first data judging unit DJ1 and the second data judging unit DJ2.

As shown in FIG. 2, the source driver 2, having a data-dependent shared buffer design and four outputs, includes a first data latch DL1˜a fourth data latch DL4, a first level shifter LS1˜a fourth level shifter LS4, a first digital-to-analog converter DAC1˜a fourth digital-analog converter DAC4, a first buffer unit BF1˜a fourth buffer unit BF4, a first output pad PAD1˜a fourth output pad PAD4, a first data judging unit DJ1˜a second data judging unit DJ2 and a first output switch unit SW1˜a second output switch unit SW2 respectively.

As shown in FIG. 2, the first data latch DL1, the first level shifter LS1, the first digital-to-analog converter DAC1, the first buffer unit BF1 and the first output pad PAD1 are coupled in series to form a first data channel; a second data latch DL2, a second level shifter LS2, a second digital-to-analog converter DAC2, a second buffer unit BF2 and a second output pad PAD2 are coupled in series to form a second data channel; the third data latch DL3, the third level shifter LS3, the third digital-to-analog converter DAC3, the third buffer unit BF3 and the third output pad PAD3 are coupled in series to form a third data channel; the fourth data latch DL4, the fourth level shifter LS4, the fourth digital-to-analog converter DAC4, the fourth buffer unit BF4 and the fourth output pad PAD4 are coupled in series to form a fourth data channel.

It should be noted that, although the first data judging unit DJ1 in FIG. 2 is coupled to the output terminal of the first data latch DL1 and the output terminal of the second data latch DL2 respectively, in fact, the first data judging unit DJ1 can be also coupled to the input terminal of the first data latch DL1 and the input terminal of the second data latch DL2 respectively, but not limited to this.

Similarly, the second data judging unit DJ2 in FIG. 2 can be coupled to the output terminal of the third data latch DL3 and the output terminal of the fourth data latch DL4 respectively, or coupled to the input terminal of the third data latch DL3 and the input terminal of the fourth data latch DL4 respectively, but not limited to this.

In addition, the first data judging unit DJ1 is further coupled to the first buffer unit BF1, the second buffer unit BF2 and the first output switch unit SW1; the first output switch unit SW1 is coupled between the output terminal of the first buffer unit BF1 and the output terminal of the second buffer unit BF2.

Similarly, the second data judging unit DJ2 is further coupled to the third buffer unit BF3, the fourth buffer unit BF4 and the second output switch unit SW2; the second output switch unit SW2 is coupled between the output terminal of the third buffer unit BF3 and the output terminal of the fourth buffer unit BF4.

In this embodiment, the first data latch DL1 and the second data latch DL2 respectively receive the first input data Dn and the second input data Dn+2 both having the first polarity (e.g., the positive polarity, but not limited to this) and the first data judging unit DJ1 judges whether the first input data Dn and the second input data Dn+2 are the same.

Similarly, the third data latch DL3 and the fourth data latch DL4 respectively receive the third input data Dn+1 and the fourth input data Dn+3 both having the second polarity (e.g., the negative polarity, but not limited to this) and the second data judging unit DJ2 judges whether the third input data Dn+1 and the fourth input data Dn+3 are the same.

The first input data Dn received by the first data latch DL1 is sequentially processed by the first level shifter LS1 and converted from the digital signal to the analog signal by the first digital-to-analog converter DAC1 and then the analog signal is temporarily stored in the first buffer unit BF1. Similarly, the second input data Dn+2 received by the second data latch DL2 is sequentially processed by the second level shifter LS2 and converted from the digital signal to the analog signal by the second digital-to-analog converter DAC2 and then the analog signal is temporarily stored in the second buffer unit BF2; the third input data Dn+1 received by the third data latch DL3 is sequentially processed by the third level shifter LS3 and converted from the digital signal to the analog signal by the third digit-to-analog converter DAC3 and then the analog signal is temporarily stored in the third buffer unit BF3; the fourth input data Dn+3 received by the fourth data latch DL4 is sequentially processed by the fourth level shifter LS4 and converted from the digital signal to the analog signal by the fourth digital-to-analog converter DAC4 and then the analog signal is temporarily stored in the fourth buffer unit BF4.

When the first data judging unit DJ1 determines that the first input data Dn and the second input data Dn+2 are not the same, that is to say, the first input data Dn temporarily stored in the first buffer unit BF1 and the second input data Dn+2 temporarily stored in the second buffer unit BF2 are different. As shown in FIG. 2, the first data determining unit DJ1 will still activate the first buffer unit BF1 and the second buffer unit BF2 and disconnects the first output switch unit SW1, so that the output terminal of the first buffer unit BF1 is not coupled to the output terminal of the second buffer unit BF2, and the first input data Dn and the second input data Dn+2 are outputted by the first buffer unit BF1 and the second buffer unit BF2 to the first output pad PAD1 and the second output pad PAD2 respectively.

Similarly, when the second data judging unit DJ2 determines that the third input data Dn+1 and the fourth input data Dn+3 are not the same, that is to say, the third input data Dn+1 temporarily stored in the third buffer unit BF3 and the fourth input data Dn+3 temporarily stored in the fourth buffer unit BF4 are different. As shown in FIG. 2, the second data judging unit DJ2 will still activate the third buffer unit BF3 and the fourth buffer unit BF4 and disconnect the second output switch unit SW2, so that the output terminal of the third buffer unit BF3 is not coupled to the output terminal of the fourth buffer unit BF4, and the third input data Dn+1 and the fourth input data Dn+3 are outputted by the third buffer unit BF3 and the fourth buffer unit BF4 to the third output pad PAD3 and the fourth output pad PAD4 respectively.

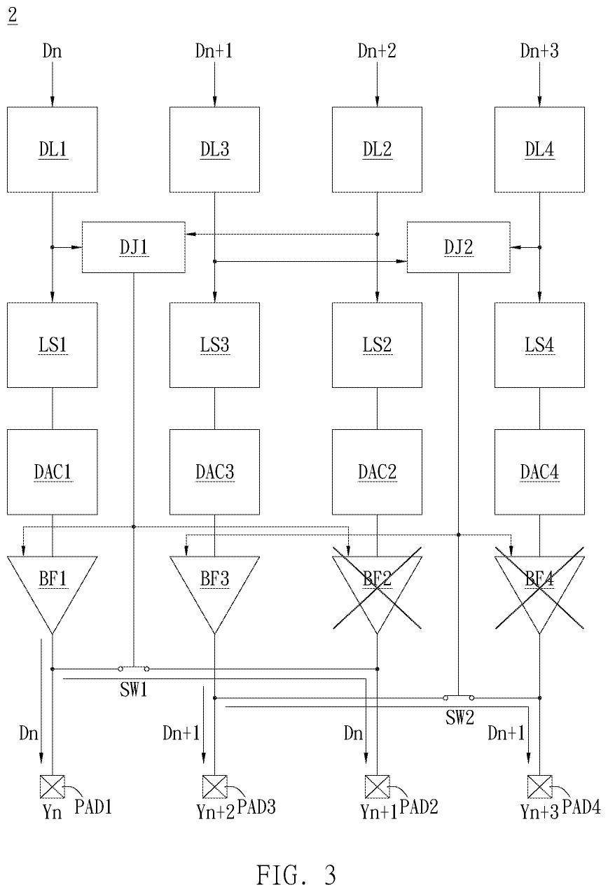

Next, please refer to FIG. 3. FIG. 3 illustrates a schematic diagram showing that the source driver 2 with the data dependent shared buffer design in FIG. 2 simultaneously disconnects the first output switch unit SW1 and the second output switch unit SW2 and only starts the first buffer unit BF1 and the third buffer unit BF3 according to the determination result of the first data judging unit DJ1 and the second data judging unit DJ2.

When the first data judging unit DJ1 determines that the first input data Dn and the second input data Dn+2 are the same, that is to say, the first input data Dn temporarily stored in the first buffer unit BF1 and the second input data Dn+2 temporarily stored in the second buffer unit BF2 are the same. In order to reduce unnecessary power consumption caused by simultaneously starting the first buffer unit BF1 and the second buffer unit BF2, the first data judging unit DJ1 turns off the first buffer unit BF1 or the second buffer unit BF2 and conducts the first output switching unit. SW1.

For example, the first data judging unit DJ1 in FIG. 3 activates the first buffer unit BF1 and turns off the second buffer unit BF2 (indicated by X) and conducts the first output switch unit SW1, so that the output terminal of the first buffer unit BF1 and the output terminal of the second buffer unit BF2 are coupled to each other, and the first input data Dn is simultaneously outputted by the activated first buffer unit BF1 to the first output pad PAD1 and the second output pad PAD2. In fact, the first data judging unit DJ1 can also activate the second buffer unit BF2 and turn off the first buffer unit BF1 and conduct the first output switch unit SW1, so that the output terminal of the first buffer unit BF1 and the output terminal of the second buffer unit BF2 are coupled to each other, and the second input unit Dn+2 is simultaneously outputted by the activated second buffer unit BF2 to the first output pad PAD1 and the second output pad PAD2.

It should be noted that, since the first input data Dn and the second input data Dn+2 are the same, whether the first input data Dn or the second input data Dn+2 is simultaneously outputted to the first output pad PAD1 and the second output pad PAD2, the first output data Yn and the second output data Yn+2 outputted by the first output pad PAD1 and the second output pad PAD2 will not be affected. Therefore, the source driver 2 with the data dependent shared buffer design of the invention can effectively achieve the energy saving effect of reducing the overall power consumption of the source driver 2.

Similarly, when the second data judging unit DJ2 determines that the third input data Dn+1 and the fourth input data Dn+3 are the same, that is to say, the third input data Dn+1 temporarily stored in the third buffer unit BF3 and the fourth input data Dn+3 temporarily stored in the fourth buffer unit BF4 are the same. In order to reduce unnecessary power consumption caused by simultaneously starting the third buffer unit BF3 and the fourth buffer unit BF4, the second data judging unit DJ2 turns off the third buffer unit BF3 or the fourth buffer unit BF4 and conducts the second output switch unit SW2.

For example, the second data judging unit DJ2 in FIG. 3 activates the third buffer unit BF3 and turns off the fourth buffer unit BF4 (indicated by X) and conducts the second output switch unit SW2, so that the output terminal of the unit BF3 and the output terminal of the fourth buffer unit BF4 are coupled to each other, and the third input data Dn+1 is outputted by the activated third buffer unit BF3 to the third output pad PAD3 and the fourth output pad PAD4 simultaneously. In fact, the second data judging unit DJ2 can also activate the fourth buffer unit BF4 and turn off the third buffer unit BF3 and conduct the second output switch unit SW2, so that the output terminal of the third buffer unit BF3 and the output terminal of the fourth buffer unit BF4 are coupled to each other, and the fourth input unit Dn+3 is simultaneously outputted by the activated fourth buffer unit BF4 to the third output pad PAD3 and the fourth output pad PAD4.

It should be noted that since the third input data Dn+1 and the fourth input data Dn+3 are the same, no matter the third input data Dn+1 or the fourth input data Dn+3 is simultaneously outputted to the third output pad PAD3 and the fourth output pad PAD4, the third output data Yn+2 and the fourth output data Yn+3 outputted by the third output pad PAD3 and the fourth output pad PAD4 will not be affected. Therefore, the source driver 2 with the data dependent shared buffer design of the invention can effectively achieve the energy saving effect of reducing the overall power consumption of the source driver 2.

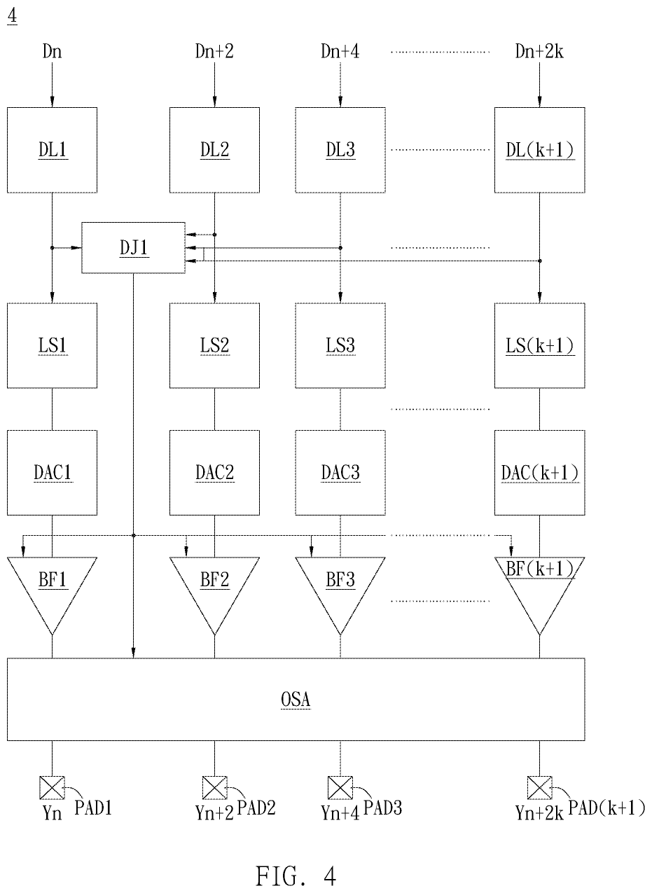

Another embodiment of the invention is also a source driver with a data dependent shared buffer design. In this embodiment, the source driver with the data dependent shared buffer design can be applied to the liquid crystal display device, but not limited to this. Please refer to FIG. 4. FIG. 4 illustrates a schematic diagram showing that a source driver 4 with a data dependent shared buffer design controls the switching of the output switch array OSA according to the determination result of the data judging unit DJ and activates only a part of the buffer units BF1˜BF(k+1) in this embodiment.

As shown in FIG. 4, the source driver 4 with the data-dependent shared buffer design can include (k+1) data latches DL1˜DL(k+1), at least one data judging unit DJ, (k+1) level shifters LS1˜LS(k+1), (k+1) digital-to-analog converters DAC1˜DAC(k+1), (k+1) buffer units BF1˜BF(k+1), an output switch array OSA and (k+1) output pads PAD1˜PAD(k+1). The data judging unit DJ is respectively coupled to the output terminals of the (k+1) data latches DL1˜DL(k+1) or the data judging unit DJ respectively coupled to the input terminals of the (k+1) data latches DL1˜DL(k+1), and the data judging unit DJ is used to judge whether the (k+1) input data Dn˜Dn+2k having the same polarity are the same or not, and k is a positive integer. In addition, the data judging unit DJ is also coupled to the (k+1) buffer units BF1˜BF(k+1) and the output switch array OSA respectively. The output switch array OSA is coupled to the data judging unit DJ and the output terminals of the (k+1) buffer units BF1˜BF(k+1) and used for switching the coupling relationship between the output terminals of the (k+1) buffer units BF1˜BF(k+1) and the (k+1) output pads PAD1˜PAD(k+1) under the control of the data judging unit DJ.

When the data judging unit DJ determines that the (k+1) input data Dn, Dn+2, Dn+2k having the same polarity are different, the data judging unit DJ controls the output switch array OSA to switch the output terminals of the(k+1) buffer units BF1˜BF(k+1) to be coupled to the corresponding (k+1) output pads PAD1˜PAD(k+1) respectively, so that the (k+1) buffer units BF1˜BF(k+1) can output the (k+1) input data Dn, Dn+2, . . . , Dn+2k to the (k+1) output pads PAD1˜PAD(k+1) respectively.

Taking FIG. 4 as an example, if the data judging unit DJ determines that the (k+1) input data Dn, Dn+2, . . . , Dn+2k having the same polarity are different, the data judging unit DJ controls the output switch array OSA to switch the coupling relationship between the output terminals of the (k+1) buffer units BF1˜BF(k+1) and the corresponding (k+1) output pads PAD1˜PAD(k+1), so that the buffer unit BF1 can be coupled to the output pad PAD1 through the output switch array OSA and output the input data Dn to the output pad PAD1; the buffer unit BF2 can be coupled to the output pad PAD2 through the output switch array OSA and output the input data Dn+2 to the output pad PAD2; the buffer unit BF3 can be coupled to the output pad PAD3 through the output switch array OSA and output the input data Dn+4 to the output pad PAD3, . . . , the buffer unit BF(k+1) can be coupled to the output pad PAD (k+1) through the output switch array OSA and output the input data Dn+2k to the output pad PAD(k+1).

When the data judging unit DJ determines that m input data among the (k+1) input data Dn˜Dn+2k having the same polarity are the same (m is a positive integer greater than 1), that is to say, there will be m buffer units among the (k+1) buffer units temporarily storing the m input data, and the data judging unit DJ will turn off (m+1) buffer units among the m buffer units and only turn on one buffer unit among the m buffer units. Then, the data judging unit DJ will control the output switch array OSA to switch the output terminal of the only turned-on buffer unit to be simultaneously coupled to m output pads corresponding to the m output pads among the (k+1) output pads PAD1˜PAD(k+1), so that the only turned-on buffer unit can simultaneously output its temporarily stored input data to the m output pads.

Taking FIG. 4 as an example, if the data judging unit DJ determines that three input data Dn, Dn+2 and Dn+4 among the (k+1) input data Dn˜Dn+2k having the same polarity are the same, the data judging unit DJ will turn off two buffer units (for example, the buffer units BF2 and BF3) among the three buffer units BF1, BF2 and BF3 temporarily storing the input data Dn, Dn+2 and Dn+4 respectively and only turn on one buffer unit (for example, the buffer unit BF1). Then, the data judging unit DJ will control the output switch array OSA to switch the only turned-on buffer unit BF1 to be simultaneously coupled to the output pads PAD1, PAD2 and PAD3 corresponding to the buffer units BF1, BF2 and BF3, so that the only turned-on buffer unit BF1 can simultaneously output its temporarily stored input data Dn to the output pads PAD1, PAD2 and PAD3.

It should be noted that since the input data Dn, Dn+2 and Dn+4 are the same, no matter the input data Dn, Dn+2 or Dn+4 is simultaneously outputted to the output pads PAD1, PAD2 and PAD3, the output data Yn, Yn+2 and Yn+4 outputted by the output pads PAD1, PAD2 and PAD3 will not be affected, so that the source driver 4 of the invention with the data dependent shared buffer design can effectively achieve the energy saving effect of reducing the overall power consumption of the source driver 4.

Regarding to other input data Dn+6˜Dn+2k different from Dn, Dn+2 and Dn+4 among the (k+1) input data Dn˜Dn+2k having the same polarity, the data judging unit DJ can control the output switch array OSA to switch the coupling relationship between the output terminals of the buffer units BF4˜BF(k+1) temporarily storing the input data Dn+6˜Dn+2k and the corresponding output pads PAD4˜PAD(k+1) respectively, so that the buffer unit BF4 can be coupled to the output pad PAD4 through the output switch array OSA and output the input data Dn+6 to the output pad PAD4, . . . , the buffer unit BF(k+1) can be coupled to the output pad PAD(k+1) through the output switch array OSA and output the input data Dn+2k to the output pad PAD(k+1). The rest of the situations can be deduced by analogy, so it will not be repeated here.

Compared to the prior art, the source driver with the data dependent shared buffer design in the invention can adjust the number of the buffer units used by detecting whether the input data of each channel is the same, so as to avoid the unnecessary power consumption caused by activating all buffer units simultaneously. Therefore, the invention can effectively reduce the overall power consumption of the source driver and achieve the energy saving effect.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A source driver with a data dependent shared buffer design, applied to a display, the source driver comprising:
a first data judging unit, configured to judge whether a first input data and a second input data having a first polarization are the same;
a first buffer unit, coupled to the first data judging unit and configured to temporarily store the first input data;
a second buffer unit, coupled to the first data judging unit and configured to temporarily store the second input data; and
a first output switch unit, coupled to the first data judging unit, an output terminal of the first buffer unit and an output terminal of the second buffer unit respectively;
wherein when a judging result of the first data judging unit is YES, the first data judging unit turns off the first buffer unit or the second buffer unit and conducts the first output switch unit, so that the output terminal of the first buffer unit and the output terminal of the second buffer unit are coupled.

2. The source driver of claim 1, further comprising:
a first output pad, coupled to the first buffer unit; and
a second output pad, coupled to the second buffer unit;
wherein when the first data judging unit turns off the first buffer unit, the second buffer unit outputs the second input data to the first output pad and the second output pad simultaneously; when the first data judging unit turns off the second buffer unit, the first buffer unit outputs the first input data to the first output pad and the second output pad simultaneously.

3. The source driver of claim 2, wherein when the judging result of the first data judging unit is NO, the first data judging unit disconnects the first output switch unit, so that the output terminal of the first buffer unit and the output terminal of the second buffer unit are disconnected, and the first buffer unit outputs the first input data to the first output pad and the second buffer unit outputs the second input data to the second output pad.

4. The source driver of claim 1, further comprising:
a first data latch, configured to receive and latch the first input data; and
a second data latch, configured to receive and latch the second input data;
wherein the first data judging unit is coupled to input terminals of the first data latch and the second data latch or the first data judging unit is coupled to output terminals of the first data latch and the second data latch.

5. The source driver of claim 4, further comprising:
a first level shifter, coupled to the output terminal of the first data latch and configured to shift a voltage level of the first input data;
a second level shifter, coupled to the output terminal of the second data latch and configured to shift a voltage level of the second input data;
a first digital-to-analog converter, coupled between the first level shifter and the first buffer unit and configured to convert the first input data from digital signal to analog signal and then transmit the converted first input data to the first buffer unit; and
a second digital-to-analog converter, coupled between the second level shifter and the second buffer unit and configured to convert the second input data from digital signal to analog signal and then transmit the converted second input data to the second buffer unit.

6. The source driver of claim 1, further comprising:
a second data judging unit, configured to judge whether a third input data and a fourth input data having a second polarization are the same, wherein the second polarization is different from the first polarization;
a third buffer unit, coupled to the second data judging unit and configured to temporarily store the third input data;
a fourth buffer unit, coupled to the second data judging unit and configured to temporarily store the fourth input data; and
a second output switch unit, coupled to the second data judging unit, an output terminal of the third buffer unit and an output terminal of the fourth buffer unit respectively;
wherein when a judging result of the second data judging unit is YES, the second data judging unit turns off the third buffer unit or the fourth buffer unit and conducts the second output switch unit, so that the output terminal of the third buffer unit and the output terminal of the fourth buffer unit are coupled.

7. The source driver of claim 6, further comprising:
a third output pad, coupled to the third buffer unit; and
a fourth output pad, coupled to the fourth buffer unit;
wherein when the second data judging unit turns off the third buffer unit, the fourth buffer unit outputs the fourth input data to the third output pad and the fourth output pad simultaneously; when the second data judging unit turns off the fourth buffer unit, the third buffer unit outputs the third input data to the third output pad and the fourth output pad simultaneously.

8. The source driver of claim 7, wherein when the judging result of the second data judging unit is NO, the second data judging unit disconnects the second output switch unit, so that the output terminal of the third buffer unit and the output terminal of the fourth buffer unit are disconnected, and the third buffer unit outputs the third input data to the third output pad and the fourth buffer unit outputs the fourth input data to the fourth output pad.

9. The source driver of claim 6, further comprising:
a third data latch, configured to receive and latch the third input data; and
a fourth data latch, configured to receive and latch the fourth input data;
wherein the second data judging unit is coupled to input terminals of the third data latch and the fourth data latch or the second data judging unit is coupled to output terminals of the third data latch and the fourth data latch.

10. The source driver of claim 9, further comprising:
a third level shifter, coupled to the output terminal of the third data latch and configured to shift a voltage level of the third input data;
a fourth level shifter, coupled to the output terminal of the fourth data latch and configured to shift a voltage level of the fourth input data;
a third digital-to-analog converter, coupled between the third level shifter and the third buffer unit and configured to convert the third input data from digital signal to analog signal and then transmit the converted third input data to the third buffer unit; and
a fourth digital-to-analog converter, coupled between the fourth level shifter and the fourth buffer unit and configured to convert the fourth input data from digital signal to analog signal and then transmit the converted fourth input data to the fourth buffer unit.

11. A source driver with a data dependent shared buffer design, applied to a display, the source driver comprising:
at least one data judging unit, configured to judge whether (k+1) input data having the same polarization are the same, wherein k is a positive integer;
(k+1) buffer units, coupled to the at least one data judging unit and configured to temporarily store the (k+1) input data respectively;
an output switch array, coupled to the at least one data judging unit and output terminals of the (k+1) buffer units respectively; and
(k+1) output pads, coupled to the output switch array, corresponding to the (k+1) buffer units respectively;
wherein when the at least one data judging unit determines that m input data among the (k+1) input data are the same, the m input data are temporarily stored in m buffer units among the (k+1) buffer units, the at least one data judging unit turns off (m−1) buffer units among the m buffer units and the output switch array controls an output terminal of an only turned-on buffer unit among the m buffer units to be coupled to m output pads corresponding to the m buffer units among the (k+1) output pads simultaneously, so that the only turned-on buffer unit can output an input data temporarily stored in the only turned-on buffer unit to the m output pads simultaneously, m is a positive integer larger than 1.

12. The source driver of claim 11, wherein when the at least one data judging unit determines that the (k+1) input data are different, the output switch array controls output terminals of the (k+1) buffer units to be coupled to the corresponding (k+1) output pads respectively, so that the (k+1) buffer units can output the (k+1) input data to the (k+1) buffer units respectively.

13. The source driver of claim 11, further comprising:
(k+1) data latches, coupled to the at least one data judging unit and configured to receive and latch the (k+1) input data;
wherein the at least one data judging unit is coupled to input terminals of the (k+1) data latches or the at least one data judging unit is coupled to output terminals of the (k+1) data latches.

14. The source driver of claim 13, further comprising:
(k+1) level shifters, coupled to output terminals of the (k+1) data latches and configured to shift voltage levels of the (k+1) input data respectively; and
(k+1) digital-to-analog converters, coupled between the (k+1) level shifters and the (k+1) buffer units and configured to convert the (k+1) input data from digital signal to analog signal respectively and then transmit the converted (k+1) input data to the (k+1) buffer units respectively.
